(19) United States
(12) Patent Application Publication
(10) Pub. No.: US 2016/0061237 A1
(43) Pub. Date: Mar. 3, 2016

(54) APPARATUS AND METHOD TO ENHANCE HEATING PERFORMANCE OF A VEHICLE VENTILATION SYSTEM

(71) Applicant: FORD GLOBAL TECHNOLOGIES, LLC, Dearborn, MI (US)

(72) Inventors: Manfred Koberstein, Troy, MI (US); Ranganathan Madhavan, Canton, MI (US); Kurt Francis Wingert, Highton (AU); Denis Gerard O'Shannessy, Melbourne (AU); Gary D. Mullen, Plymouth, MI (US); Harold Li, Nanjing (CN); Hai Feng Xing, Nanjing (CN)

(21) Appl. No.: 14/472,474

(22) Filed: Aug. 29, 2014

(51) Int. Cl. F15D 1/02; B60H 1/02

(52) U.S. Cl. CPC F15D 1/025; B60H 1/02

(57) ABSTRACT

A vehicle ventilation system includes an airflow circuit providing a flow pathway between a blower, an evaporator core, a heater core and an airflow restrictor. The airflow restrictor is provided downstream from the heat or cold and functions to increase the residence time of the air in the heater core to enhance heating performance of the vehicle ventilation system.

### TECHNICAL FIELD

This document relates generally to the motor vehicle field and, more particular, to a method and apparatus for enhancing the heating performance of a vehicle ventilation system.

### BACKGROUND

A large number of factors determine the heating efficiency and performance of a vehicle ventilation system. These factors go well beyond the size and design of the heater core where heat exchange takes place between the air circulating through the ventilation system and the coolant fluid circulating through the engine. The factors include, but are not necessarily limited to, the size of the engine and the presence or absence of other equipment that affects ambient airflow into the cabin of the vehicle or cooling airflow to the engine.

For example, a pollen filter allows more cold airflow into the vehicle cabin. Accordingly, a vehicle equipped with a pollen filter will require the ventilation system to perform more efficiently and effectively in order to maintain desired occupant comfort. As another example, many cars are now being equipped with active grill shutters (AGS). When open, these shutters allow air to flow through the radiator into the engine compartment to promote cooling. However, in colder winter conditions, when that cooling air is not needed, the shutters close, rerouting air around the vehicle to lessen aerodynamic drag and reduce fuel consumption. Significantly, these shutters also drastically affect heating performance of the vehicle ventilation system. More specifically, when the shutters are closed, the engine warms up more quickly in cold weather and operates at higher temperatures thereby substantially improving the heating performance of the vehicle ventilation system.

In an effort to meet customer demands, many vehicles are offered with two or more engine options. In an effort to control production costs, these same vehicles are often offered with a single heater core and ventilation system. While the heating performance of the vehicle ventilation system may be very effective with one engine option, it may not be with another. For example, the heating and ventilation system may provide optimum performance when the vehicle is equipped with a larger engine including active grill shutters. However, when that same vehicle is equipped with a smaller engine, no active grill shutters and a pollen filter, allowing more ambient airflow into the vehicle cabin, heating performance may suffer.

This document discloses an apparatus and method for enhancing the performance of a vehicle heater in this latter situation so that a single vehicle ventilation system may be quickly, easily and inexpensively adapted to provide optimum performance when matched with more than one engine.

### SUMMARY

In accordance with the purposes and benefits described herein, a vehicle ventilation system is provided. That ventilation system comprises an air flow conduit which provides a flow pathway between a blower, an evaporator core, a heater core and an air flow restrictor. The evaporator core provides for cooling and de-humidifying of air forced through the conduit by the air blower. In contrast, the heater core functions to warm the air forced through the conduit by the blower, while the air flow restrictor, downstream from the heater core, increases the residence time of the air in the heater core to enhance heating performance of the vehicle ventilation system.

In one possible embodiment of the ventilation system, the heater core includes a cover defining an air manifold between the heater core and the cover. That cover includes a slot and the air flow restrictor is mounted in the slot of the cover.

In one possible embodiment the air flow restrictor comprises a plate including a plurality of apertures. Each aperture has a diameter of between 1.5 mm and 3.0 mm and a total airflow area of the plurality of apertures is between 35% and 75% of a total airflow cross-section area of the ventilation system. In one embodiment the plurality of apertures are also all uniform in diameter. Further the airflow restrictor includes a mounting base having a surface for abutting the cover with the plate projecting from that surface.

In another possible embodiment the airflow restrictor comprises a frame forming a grid including a plurality of openings. A mesh extends across those openings in the grid. The mesh is made from a material selected from a group including polypropylene fiber, glass fiber and mixtures thereof having a hole size range of between about 0.3 mm and 1.0 mm. This airflow restrictor also includes a mounting base having a surface for abutting the cover with the frame projecting from the surface.

In accordance with an additional aspect, an airflow restrictor is provided for a vehicle ventilation system. Further a method is provided for improving the heating performance of a vehicle ventilation system including an airflow circuit and a heater core. That method may be broadly described as comprising the step of providing an airflow restrictor in the airflow circuit downstream from the heater core. This includes mounting the airflow restrictor to a cover of the heater core.

In the following description, there are shown and described several preferred embodiments of the vehicle ventilation system and airflow restrictor. As it should be realized, the vehicle ventilation system and airflow restrictor is capable of other, different embodiments and its several details are capable of modification in various, obvious aspects all without departing from the vehicle ventilation system and restrictor as set forth and described in the following claims. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the vehicle ventilation system and airflow restrictor and together with the description serve to explain certain principles thereof. In the drawings:

FIG. 1 is a schematical block diagram of the vehicle ventilation system.

FIG. 2 is a detailed perspective view of the heater core, heater core cover and air restrictor.

FIG. 3 is a detailed perspective view of a first embodiment of airflow restrictor.

FIG. 4 is a detailed perspective view of a second embodiment of airflow restrictor.

Reference will now be made in detail to the present preferred embodiment of the vehicle ventilation system and airflow restrictor, examples of which are illustrated in the accompanying drawings.

### DETAILED DESCRIPTION

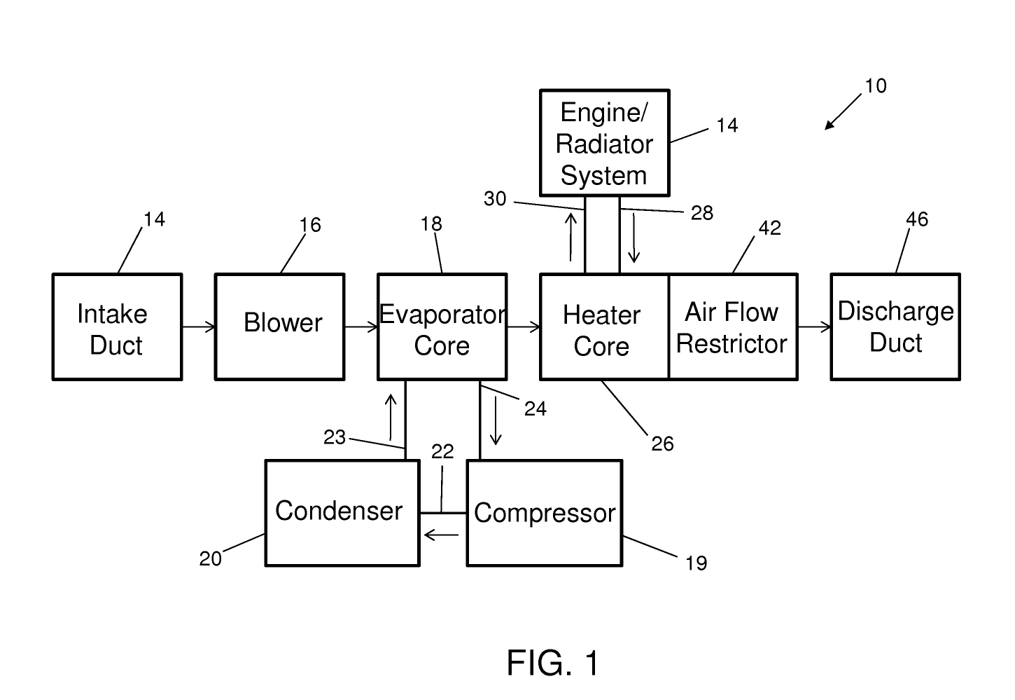

Reference is now made to FIG. 1 which schematically illustrates the vehicle ventilation system 10. For purposes of this description the middle, horizontal line of blocks represents the airflow circuit 12 and the arrows between the blocks in that horizontal line represent airflow conduits.

As illustrated, the airflow circuit 12 includes an intake duct 14. A blower 16 draws air from the cabin of the vehicle through the intake duct 14 and then forces that air through the evaporator core 18. There the air is cooled and dehumidified through heat exchange with a refrigerant fluid of the vehicle air-conditioning system. That refrigerant fluid flows between a compressor 19, a condenser 20 and the evaporator core 18 through the lines 22, 23, 24. More specifically, cool refrigerant is delivered from the condenser 20 to the evaporator core 18 through the line 23. That cool refrigerant absorbs heat from the air forced through the evaporator core 18 by the blower 16 and then is returned to the compressor 19 through the line 24. After compression, the refrigerant is routed through the line 22 to the condenser 20 where it is again cooled before being recycled back to the evaporator core 18.

After being cooled and dehumidified, the air is forced by the blower 16 through the heater core 26 located in the airflow circuit 12 downstream from the evaporator core 18. As should be appreciated, heater core 26 is connected by lines 28 and 30 to the engine and radiator system 32. Hot engine coolant is pumped through the line 28 from the engine to the heater core 26 where it heats the air being forced through the heater core by means of heat exchange before being returned to the engine/radiator system through the line 30.

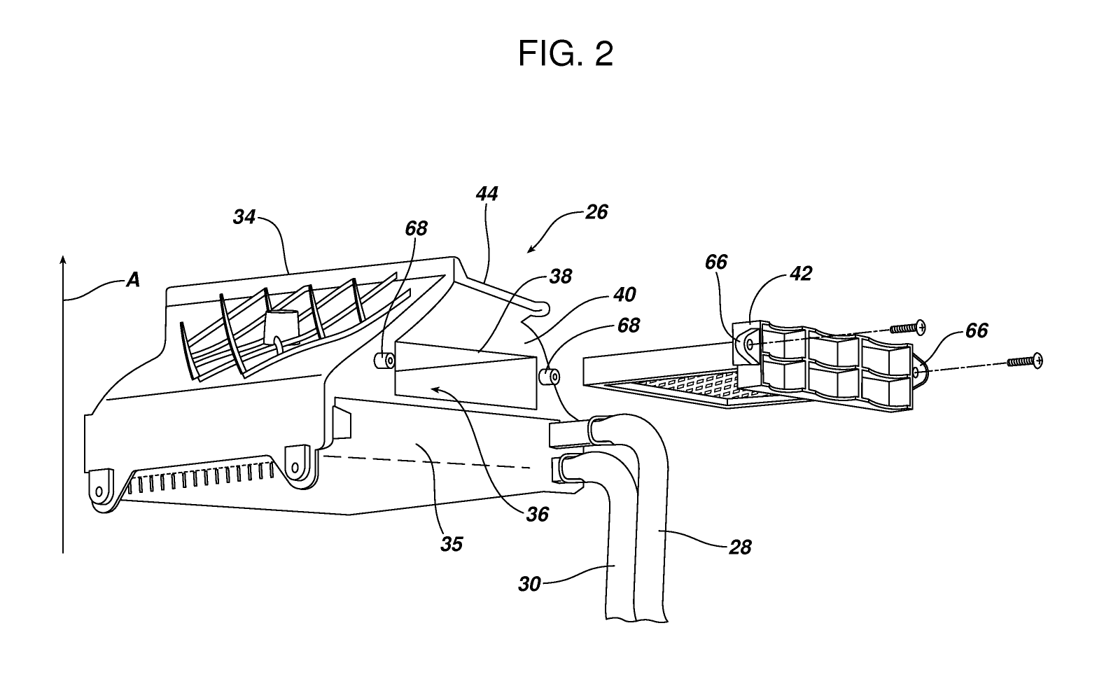

As best illustrated in FIG. 2, the heater core 26 includes a cover 34 that effectively forms an air manifold with the heat exchanger 35 of the heater core 26 on the downstream side of the heat exchanger (note direction of air movement through heater core 26 as illustrated by action arrow A). The cover 34 includes a slot 38 and a sidewall 40 that receives and holds an airflow restrictor 42, the details and function of which will be described in greater detail below.

After being dehumidified in the evaporator core 18 and warmed in the heater core 26, the air in the airflow circuit 12 is forced by the blower 16 through the airflow restrictor 42 and out of the discharge outlet 44 in the cover 34 to one or more of a number of discharge ducts 46 provided in the vehicle so as to clear fog from the windscreen and/or heat the vehicle cabin.

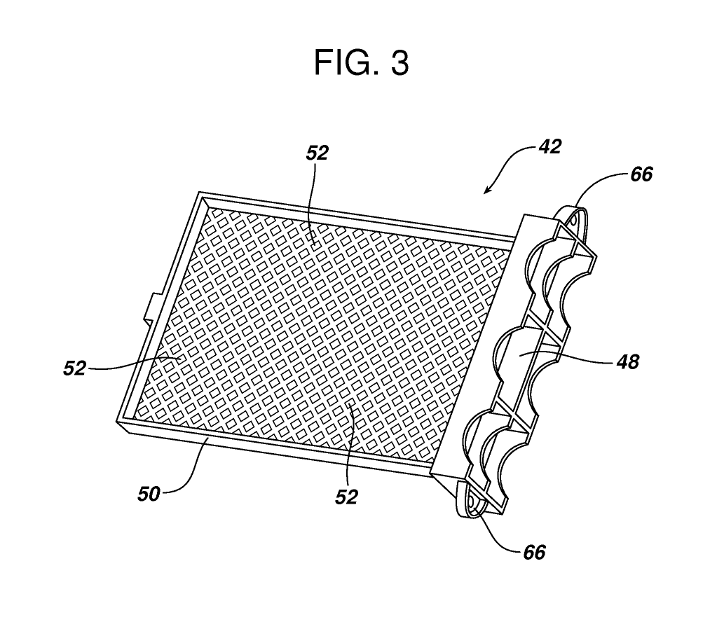

Reference is now made to FIG. 3 illustrating a first embodiment of the airflow restrictor 42. As illustrated, that airflow restrictor 42 includes a mounting base 48 and a plate 50 including a plurality of apertures 52. In one possible embodiment the apertures 52 have a diameter of between 1.5 mm and 3.0 mm. In one possible embodiment, the apertures 52 in the plate 50 are all of uniform size. Further, in one possible embodiment all of the apertures 52 have a total airflow area of between 35% and 75% of a total airflow cross-section area of the ventilation system and, more specifically, the air manifold 36 at the point where the airflow restrictor 42 is received and inserted in the cover 34. Here it should be appreciated that the airflow restrictor 42 extends across the entire cross-section dimension of the airflow manifold 36 so that any air flowing through the manifold must flow through the apertures 52 in the restrictor 42. This functions to effectively restrict airflow through the manifold to about 80% of what it would be in the absence of the airflow restrictor 42. Thus, the airflow restrictor 42 provides about a 20% decrease in airflow which increases the residence time of the air flowing through the airflow circuit 12 in the heat exchange portion 35 of the heater core 26. This increases the heating of the air before it is recirculated by the blower 16 back to the cabin of the vehicle through the discharge duct 46. In this way it is possible to increase the heating efficiency of the ventilation system 10 so as to function within desired operating parameters even when that system is matched with a smaller engine or other components such as a pollen filter that will allow increased ambient airflow to the vehicle cabin.

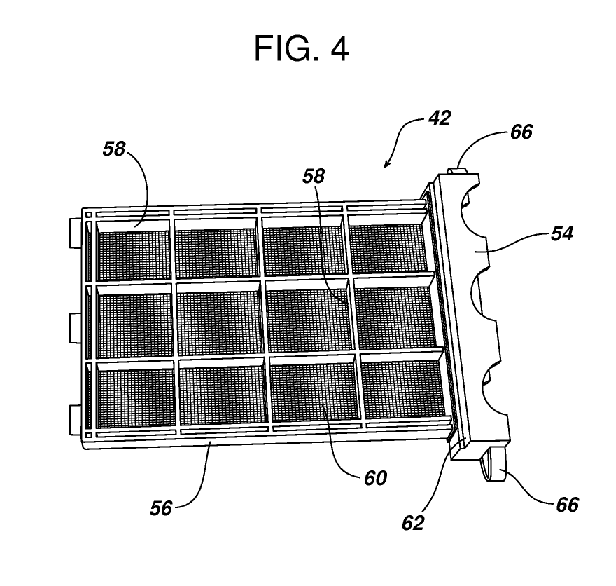

Reference is now made to FIG. 4 illustrating a second embodiment of airflow restrictor 42. This embodiment includes a mounting base 54 and a frame 56 that forms a grid including a plurality of openings 58. A mesh 60 extends across the openings 58 in the grid. The mesh 60 may be adhered, pinned, clipped or otherwise fastened to one or both sides of the frame 56. In one possible embodiment the mesh comprises a sack with an opening and an interior space, sized and shaped to receive the frame 56 which is slipped into the sack through the open end of the sack.

In any of the embodiments the mesh 60 may be made from polypropylene fiber, glass fiber and combinations thereof having a hole size range of between about 0.3 mm and 1.0 mm. Like the airflow restrictor 42 illustrated in FIG. 3, the airflow restrictor 42 illustrated in FIG. 4 provides about a 20% decrease in airflow to improve the heating performance of the vehicle ventilation system.

In either embodiment, the airflow restrictor 42 may be molded from polypropylene such as Xenopren® PP-TD-20 or other appropriate material. Further, as best illustrated in FIG. 4, either of the embodiments of airflow restrictor 42 illustrated in FIGS. 3 and 4 includes a lip or surface 62 that abuts the cover 34 when the restrictor 42 is secured in position by means of a fastener such as screws 64 received in mounting bosses 66 on the respective mounting bases 48, 54, and threadedly engaged in bosses 68 on the heater core cover.

In summary, the ventilation system 10 and airflow restrictor 42 function to provide numerous benefits. More specifically, by positioning the airflow restrictor 42 in the airflow circuit 12 just downstream from the heater core 26, airflow in the circuit is restricted to create more heat exchange at the heater core (lower airflow speed) and improve heater performance. Advantageously, this is accomplished without having any negative influence on the cooling performance of the vehicle ventilation system in the summer as airflow is not significantly decreased through the evaporator core 18 where cooling of the air takes place.

Advantageously, the airflow restrictor 42 is a simple plastic insert, similar to a cassette, which may be produced very inexpensively. Further, the airflow restrictor 42 may be located and mounted in the same slot already provided in the heater core cover 34 for a power temperature compensation device which is an electrical resistance heating device sometimes used to improve ventilation system heating performance. The air flow restrictor 42 described in this document is often a less expensive and more efficient means to achieve this end and, therefore, is a better option for many applications. Further it should be appreciated that the airflow restrictor 42 should not produce any noise or vibration and should not require any service over the life of the vehicle. At the same time the airflow restrictor 42 allows a single vehicle ventilation system to perform at optimum efficiency when matched with more than one size engine or a vehicle including various other features such as pollen filters and/or active grill shutters. This is because the amount of airflow restriction provided by the restrictor 42 may be customized to optimize ventilation system performance by varying (a) the size and number of holes or (b) the fineness of the mesh in the restrictor.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A vehicle ventilation system, comprising:
an air flow conduit providing a flow pathway between;
(a) a blower;
(b) an evaporator core for cooling and dehumidifying air forced through said conduit by said blower;
(c) a heater core for warming said air forced through said conduit by said blower; and
(d) an air flow restrictor downstream from said heater core that increases residence time of said air in said heater core to enhance heating performance of said vehicle ventilation system.

2. The system of claim 1, wherein said heater core includes a cover defining an air manifold between said heater core and said cover.

3. The system of claim 2, wherein said cover includes a slot and said air flow restrictor is mounted in said slot of said cover.

4. The system of claim 3, wherein said air flow restrictor comprises a plate including a plurality of apertures.

5. The system of claim 4, wherein said plurality of apertures have a diameter of between 1.5 mm and 3.0 mm.

6. The system of claim 5, wherein a total air flow area of said plurality of apertures is between 35% and 75% of a total air flow section area of said ventilation system.

7. The system of claim 4, wherein said plurality of apertures are of uniform diameter.

8. The system of claim 4, wherein said air flow restrictor includes a mounting base having a surface for abutting said cover, said plate projecting from said surface.

9. The system of claim 3, wherein said air flow restrictor comprises a frame forming a grid including a plurality of openings.

10. The system of claim 9, wherein a mesh extends across said openings in said grid.

11. The system of claim 10, wherein said mesh is made from a material selected from a group consisting of polypropylene fiber, glass fiber and combinations thereof having a hole size range of between about 0.3 mm and 1.0 mm.

12. The system of claim 11, wherein said air flow restrictor includes a mounting base having a surface for abutting said cover, said frame projecting from said surface.

13. An air flow restrictor for a vehicle ventilation system, comprising:
a body including a mounting base and a plate projecting from said mounting base.

14. The air flow restrictor of claim 13, wherein said plate includes a plurality of apertures.

15. The air flow restrictor of claim 14, wherein said plurality of apertures have a diameter of between 1.5 mm and 3.0 mm.

16. The air flow restrictor of claim 13, wherein said plate forms a grid including a plurality of openings.

17. The air flow restrictor of claim 16, wherein a mesh extends across said openings in said grid.

18. The air flow restrictor of claim 17, wherein said mesh is made from a material selected from a group consisting of polypropylene fiber, glass fiber and combinations thereof.

19. A method of improving heating performance of a vehicle ventilation system including an air flow circuit and a heater core comprising:
providing an air flow restrictor in said air flow circuit downstream from said heater core.

20. The method of claim 19, including mounting said air flow restrictor to a cover of said heater core.
